(19) United States
(12) Patent Application Publication
(10) Pub. No.: US 2009/0145312 A1
(43) Pub. Date: Jun. 11, 2009

(54) Portable Trash Compactor

(76) Inventor: Gary Thomas Allen, Dupont, WA (US)

Correspondence Address: Gary Thomas Allen, 2603 Macarthur st, Dupont, WA, 98327, US

(21) Appl. No.: 12/329,538

(22) Filed: Dec. 5, 2008

Related U.S. Application Data
(60) Provisional application No. 60/992,501, filed on Dec. 5, 2007.

(51) Int. Cl. B30B 9/00

(52) U.S. Cl. 100/229 R

(57) ABSTRACT

A portable trash compactor (FIG. 2) to compact trash within dumpsters or trash bins and also other waste producers and containers; comprised of a frame, motor and the use of hydraulic pump to power the arm and ram head that attaches by pins and bushings to the frame, much like that of a backhoe digger boom. It is controlled by the hydraulic controls that are attached by hydraulic hose to the hydraulic pump and hydraulic cylinders that apply pressure to swing and boom arm and weight ram or compaction head with a pivotal action and great force. Can be used as a trailer (FIG. 1) or used carried by other vehicles.

### FIELD OF THE INVENTION

This invention generally relates to trash compactors. More specifically, this invention relates to a portable trash compactor for reducing the volume occupied by trash in dumpsters or similar trash bins

### BACKGROUND OF THE INVENTION

This invention generally relates to trash compactors. More specifically, this invention relates to a portable trash compactor for reducing the volume occupied by trash in dumpsters or similar trash bins.

Many business and organizations are faced with disposing of large amounts of trash or refuse. In most cases, they are charged for disposal both by volume and frequency of disposal. A single organization may possess several dumpsters to reduce the frequency of pickups and volume of trash. Compacting the waste within the bin greatly reduces the frequency for emptying the dumpster as a large amount of internal space is otherwise unoccupied. Additionally, the nature of a large percentage of refuse tends to be mostly empty space.

What is needed is an inexpensive portable compactor that can be used with most standard dumpsters to reduce the volume of refuse and enable less frequent emptying. Also needed is a portable compactor that is very portable, very powerful, self-contained, easy to use, easy to store and maintain and also safe to use. A unit that can pay for itself quickly is also of great benefit.

Unfortunately, large compactors are expensive to purchase and install, often requiring modifications to the facility. The sheer volume of waste that has not been compacted can result in requiring the disposal truck to frequently visit the site where the trash containers are located or the requirement of numerous containers. Either alternative is costly. One way of preliminarily treating trash to ultimate disposal is compaction wherein the trash is subjected to forces which compress and distill the trash into a compact and manageable form. This conserves space until the trash can ultimately be disposed of in a suitable manner. Numerous industrial designs have been proposed and built. However, those units tend to be large and cumbersome. Additionally, they make poor use of available space, are not very portable, are also very expensive and hard to use and maintain. This invention solves these problems and more with unique compact design.

### SUMMARY OF THE INVENTION

The present invention provides a unique compact design, very portable, and useful for reducing volume occupied by trash in dumpsters and bins. The portable trash compactor includes a trailer-mounted frame with motor and controls connected to a boom arm and a ram or compaction head to make compaction easy. It can be towed or hauled from trash bin to trash bin, stores easily and is about the size of a golf cart. Compacts trash by up to one-third (⅓) of original volume with hydraulic force and a pivotal action. Its unique design allows for great ease of use and maintenance, safety and training.

### BRIEF DESCRIPTION OF DRAWINGS

FIG. 1 is side view of the portable trash compactor front half compacting trash in trash bin one embodiment of invention

FIG. 2 is a side view of the portable trash compactor complete being towed by a golf cart vehicle

### DETAILED DESCRIPTION OF THE ILLUSTRATIONS

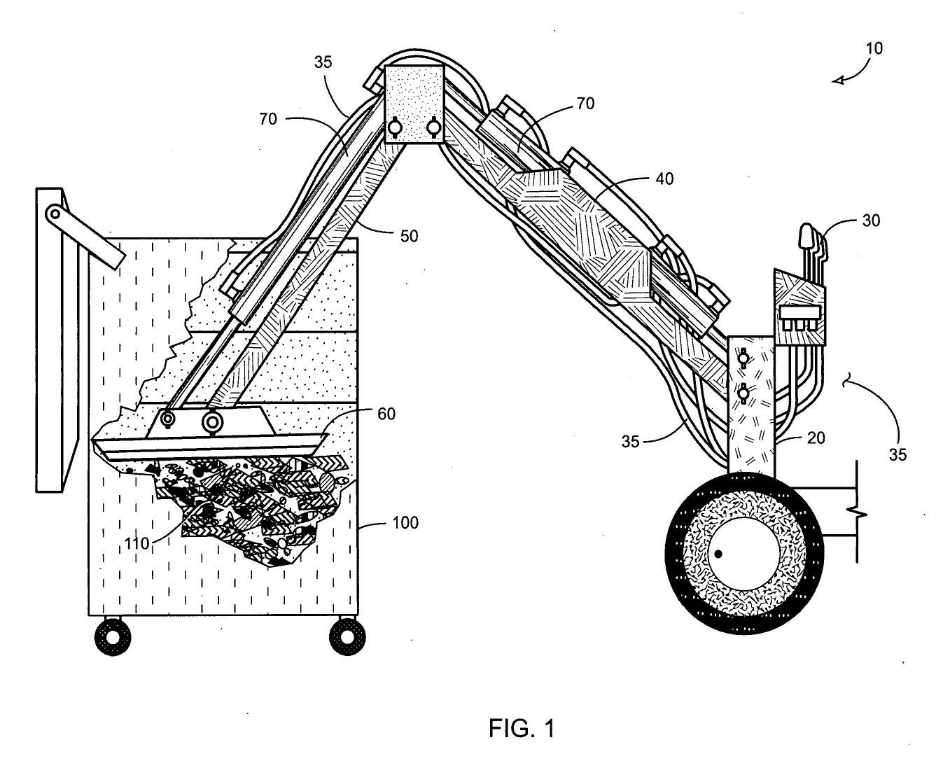

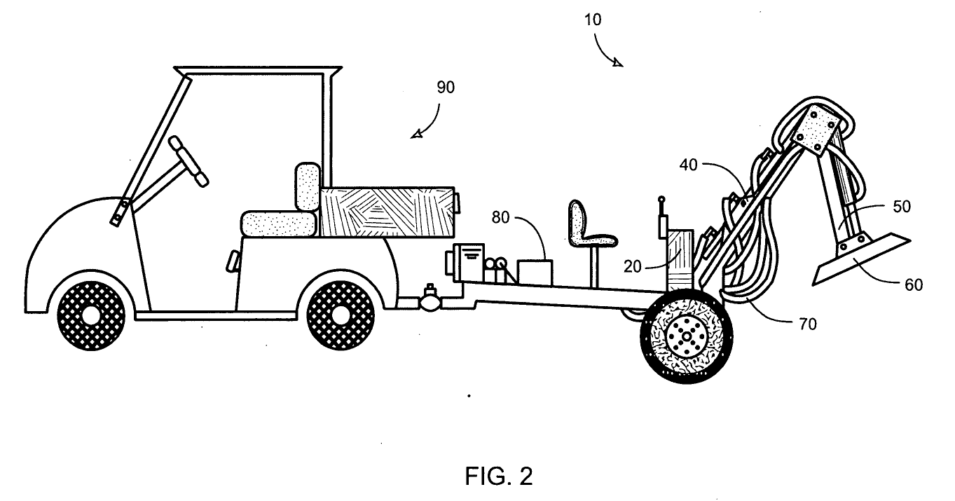

The present invention provides a portable trash compactor suitable for industrial and commercial in operation. FIG. 1 is a side view of the trash compactor in the present invention. The trash compactor (FIG. 2) is designed to efficiently utilize space and ease of movement portability. With reference to FIG. 2, the major components of the compactor (10) are schematically illustrated. Compactor (10) includes a frame (20) to which a motor (80) is attached. A hydraulic pump (20) is attached to the motor for power. Hydraulic power goes to hydraulic controls (30) that work hydraulic cylinders (70) that are connected by hydraulic fluid lines/hoses (35) to the hydraulic system that includes the hydraulic oil tank (130). This system supplies the pressure to work the boom (160) that is attached by pins and bushings to the main frame, which works like a digger broom on a backhoe. The down pressure of the main boom arm (40) has a pivotal action that presses down on the swing arm (50) and ram or compaction head (60) to compress trash (1 10) in the trash container (FIG. 1).

FIG. 1 is a side view of a portable trash compactor. An example of a working unit according to the present invention showing the invention compacting trash in a container illustrated partially sectioned.

FIG. 2 is a side view of the portable trash compactor attached to a vehicle (90).

First descriptions are of the overall structure of FIG. 1 and FIG. 2 as a working portable trash compactor as an example of a working unit having a boom arm (40) structure and attached to the swing arm (50) which holds the weighted ram or compaction head (60), all attached by pins and bushings to each other, run by hydraulic power supplied by motor (80) and hydraulic pump (20) to create down force for compression of waste.

The Present Invention

The operation positions a portable trash compactor (10) in a frame (20) of steel with welded joints with area for motor, pump, oil tank, seat and axle and wheels and hitch attached by bolts to frame. The boom arm, swing

arm and ram or compaction head are attached by pins and bushings making movable joints to allow complete arm and ram (160) to move under the hydraulic power made by the hydraulic system and controls (30). Hoses and hydraulic fluid lines (35) and cylinders (70), pump (20), oil tank (130) and motor (80) all work together to create the working system of this invention and create the forces that are used to compact materials. The framework comprised of metal frame, axle, wheels, complete boom arm and ram allows it to be portable and a mounting place for the working system.

(30) are hydraulic controls run by pump attached by hoses (35) to hydraulic booms arms (40 & 50) and head of ram or compactor (60).

(35) are hydraulic fluid lines (hoses) that attach to pump (20) and controls (30) to work the invention.

(40) is boom arm run by hydraulic power supplied by pump (20) and hoses (35) controls (30) lifting action and down force to compact the trash (100).

(50) is a swing arm attached to the boom arm (40) and the ram or compaction head (60) is attached to the working end. These parts are able to go into the dumpster to do the compacting with hydraulic down force from boom arm (40).

(60) is a weighted ram or compaction head that is attached to swing arm (50) and is controlled by hydraulic pressure.

(70) is a hydraulic cylinder that is connected with hydraulic lines (35) to pump. Controls (30) are used to control the motions of the invention.

(80) are motors. Motors used on this invention are limitless—gas, electric, diesel, etc. It powers the hydraulic pump (20) and attaches to the frame.

(90) is a vehicle that is used to transport the invention (2) to the dumpster or trash bins. Can be used with or without wheels loaded into the back of another vehicle.

(100) is a trash container. They come in many sizes and shapes. This invention (FIG. 1) is able to compact most with ease.

(110) is trash. Most household trash (FIG. 1) is readily compactable to ⅓ of original volume.

(120) is a trailer frame to transport invention (FIG. 2) to containers. Also may be loaded in another vehicle or platform.

(130) is an oil tank for hydraulic oil that flows through pump (20) and powers invention (FIG. 1).

(140) is a tire and wheel to tow invention (FIG. 2). Can be used without if carried by other means or used in place.

(150) is a seat used for comfort when using the invention (FIG. 2). Can be used without if needed.

I claim:

1. A portable trash compactor for compacting trash within a trash bin comprising:
A frame;
A backhoe type arm with a ram or compaction head with hydraulic cylinders and hoses and controls;
A boom arm is attached by pins and bushing to frame;
A useable compaction unit with or without wheels and axle can be hauled or towed by another vehicle;
A hydraulic drive unit as a means to control operation of said compactor system;
powered by motor (gas or electric or diesel, etc.) for converting motor power to hydraulic power to work compactor's hydraulic system.

2. A portable trash compactor, according to claim 1 wherein; the arm operates in a povital motion and is power by a mechanical means.

3. A portable trash compactor according to claim 1 wherein; the boom is attached by any temporary means by which operation is safe and effective.

4. A portable trash compactor according to claim 1 wherein; the drive unit is controlled by electronic motors.

5. A portable trash compactor according to claim 1 wherein; easy portability is achieved through typical hitching and towing devices.

6. A portable trash compactor according to claim 1 wherein; the compacting functions are operated by hand or foot controls.
